(19) United States
(12) Patent Application Publication
(10) Pub. No.: US 2003/0179161 A1
(43) Pub. Date: Sep. 25, 2003

(54) Circuitry and method for fast reliable start-up of plasma display panel

(75) Inventor: Yasumitsu Yamamoto, Tokyo (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: NEC PLASMA DISPLAY CORPORATION

(21) Appl. No.: 10/390,751

(22) Filed: Mar. 19, 2003

(30) Foreign Application Priority Data
Mar. 20, 2002 (JP) 079801/2002

(51) Int. Cl. G09G 3/28

(52) U.S. Cl. 345/60

(57) ABSTRACT

A method of operating a circuitry including a video data signal processing circuitry generating a video data signal and a data clock signal in response to an input video data signal, and a data electrode driver driving a plasma display panel in response to the video data signal. The method is composed of: allowing an initial setting storage unit to output an initial setting data signal representative of an initial setting of the video data signal processing circuitry, placing the video data signal processing circuitry in the initial setting in response to the initial setting data signal, producing a mute signal in response to the initial setting data signal, and disabling and enabling at least one of the video data signal processing circuitry and the data electrode driver in response to the mute signal.

### BACKGROUND OF THE INVENTION

1. Field of the Invention

The present invention is related, in general, to a plasma display panel (PDP) and method for operating the same, and more particularly, to fast reliable start-up of a plasma display panel.

2. Description of the Related Art

A plasma display panel is one of the most promising display devices. A plasma display panel typically includes an array of light emitting elements, each of which emits light through gas discharge and fluorescence. The gas discharge and fluorescence is achieved by applying pulses on electrodes disposed in the light emitting element array, including a common electrode, scan electrodes and data electrodes. The electrodes are activated in response to a video signal to develop a desired image on the panel.

FIG. 1 shows an exemplary plasma display system 100. The system 100 includes a plasma display panel 102, a common electrode driver 104, a scan electrode driver 106, a data electrode driver 108, and a video data signal generator 110.

The common electrode driver 104 and the scan electrode driver 106 respectively drive a common electrode and an array of scan electrodes disposed in the plasma display panel 102.

The video data signal generator 110 provides the data electrode driver 108 with a video data signal VIDEO_OUT and a data clock signal CLK_OUT in response to an input video data signal VIDEO_IN.

In response to the video data signal VIDEO_OUT, the data electrode driver 108 addresses and drives data electrodes disposed in the plasma display panel 102 in synchronization with the data clock signal CLK_OUT.

The data electrode driver 108 receives a blanking signal BLANK from an external circuit. In response to the blanking signal BLANK being activated, the data electrode driver 108 is deactivated.

The common electrode driver 104 and the scan electrode driver 106, which develops high-voltage pulses to maintain gas discharge in the light emitting elements, operate on a high supply voltage V_{CCH} provided from a high-voltage power supply (not shown).

On the other hand, the data electrode driver 108 and the video data signal generator 110, which do not require high-voltage supply, operate on a logic power supply voltage V_{CCL} supplied from a logic circuit voltage source (not shown). The logic power supply voltage V_{CCL} is lower than the high supply voltage V_{CCH} provided for the common electrode driver 104 and the scan electrode driver 106.

FIG. 2 shows a schematic of the video data signal generator 110. The video data signal generator 110 includes an initial setting storage circuit 112 and a video data signal processor 114.

The initial setting storage circuit 112 stores therein data on an initial setting of the video data signal processor 114. The initial setting typically includes conditions of sub-field coding and weighting for generating graylevels to be displayed on each light emitting element. The sub-field coding involves defining sub-fields for each field of the input video data signal. One field typically includes eight sub-fields. Weighting for generating graylevels involves determining a number of times of discharge of each light emitting element for each sub-field.

When the system 100 is started up, the initial setting storage circuit 112 provides an initial setting signal INT_SET representative of the initial setting of the video data signal processor 114.

The video data signal processor 114 decodes the input video data signal VIDEO_IN in accordance with the initial setting defined by the initial setting storage circuit 112 to output the video data signal VIDEO_OUT and the data clock signal CLK_OUT to the data electrode driver 108. When the system 100 is started up, the video data signal processor 114 receives the initial setting signal INT_SET to be placed in the initial setting represented by the initial setting signal.

The video data signal processor 114 receives a mute signal MUTE from a mute signal generator (not shown). The mute signal MUTE disables the input of the input video data signal VIDEO_IN to the video data signal processor 114.

The mute signal MUTE is used for avoiding an undesirable image being displayed on the plasma display panel 102 when the system 100 is started up. The video data signal processor 114 requires a considerable period to complete the initial setting after the start-up of the system 100, because the video data signal processor 114 needs to receive the initial setting signal INT_SET from the initial setting storage circuit 112. Outputting the video data signal VIDEO_OUT and the data clock CLK_OUT before the completion of the initial setting results in the display of an undesirable image on the plasma display panel 102. The mute signal MUTE is activated to disable the input video data signal VIDEO_IN for a predetermined period after the start-up of the system 100, thereby prevents an undesirable image from being displayed on the plasma display panel 102.

FIG. 3 shows a start-up sequence of the plasma display system 100. In response to a master electrical switch of the system 100 being turned on, the logic circuit power supply starts to provide the logic circuit supply voltage V_{CCL} for the video data signal generator 10. The initial setting storage circuit 112, which operates on the logic circuit supply voltage V_{CCL}, then starts to provide the initial setting signal INI_SET for the video data signal processor 114. Then, the high-voltage power supply starts to provide a high supply voltage V_{CCH} for the common electrode driver 104 and the scan electrode driver 106.

In the meantime, the mute signal MUTE is activated in response to the turn-on of the supply voltage V_{CCL} as shown in FIG. 3C. The mute signal MUTE remains activated for a predetermined period to disable the input video data signal VIDEO_IN. After the predetermined period expires, the mute signal MUTE is then deactivated to allow the video data signal processor 114 to receive the input video data signal VIDEO_IN. The video data signal processor 114 then starts to output the video data signal VIDEO_OUT and the data clock CLK_OUT in response to the input video data signal VIDEO_IN.

The use of the mute signal MUTE effectively prevents the plasma display panel 102 from displaying an undesirable image thereon. However, the use of the mute signal MUTE increases the period required for the plasma display system 100 to be started up after the master electrical switch is turned on.

A need exists to provide architecture that facilitates fast reliable start-up of a plasma display system.

Another factor causing undesirable images to be displayed on the plasma display panel 102 is that sufficiently high supply voltage is not supplied to the common electrode driver 104 and the scan electrode driver 106. An accidental drop of the high supply voltage may result in displaying undesirable images, such as inhomogeneous images, blinking images and so on. Besides, turn-off of the high supply voltage V_{CCH} in response to the turn-off of the master electrical switch of the system 100 may results in displaying undesirable images.

A need exists to provide architecture that avoids undesirable images being displayed when the drivers are not provided with sufficiently high supply voltage.

A technology which may be related to the present invention is disclosed in Japanese Laid Open Patent Application (JP-A-Heisei 7-140434). The disclosed technology involves the use of a mute signal in an LCD (liquid crystal display) driver for disabling a video signal in response to a period of turn-off of a back light.

### SUMMARY OF THE INVENTION

Therefore, an object of the present invention is to provide architecture that facilitates fast reliable start-up of a plasma display system.

Another object of the present invention is to provide architecture that avoids undesirable images being displayed when the drivers are not provided with sufficiently high supply voltage.

In an aspect of the present invention, a method is provided for operating a circuitry including a video data signal processing circuitry generating a video data signal and a data clock signal in response to an input video data signal, and a data electrode driver driving a plasma display panel in response to the video data signal. The method is composed of:

allowing an initial setting storage unit to output an initial setting data signal representative of an initial setting of the video data signal processing circuitry;

placing the video data signal processing circuitry in the initial setting in response to the initial setting data signal;

producing a mute signal in response to the initial setting data signal; and

disabling and enabling at least one of the video data signal processing circuitry and the data electrode driver in response to the mute signal.

It is advantageous that the allowing includes providing a supply voltage for the initial setting storage circuit, the producing the mute signal includes activating the mute signal in response to turn-on of the supply voltage, and the disabling and enabling includes disabling the at least one of the video data signal processing circuitry and the data electrode driver in response to the mute signal being activated.

It is advantageous that the producing the mute signal includes:

monitoring the initial setting signal to detect completion of transfer of the initial setting, and

deactivating the mute signal in response to the completion of the transfer of the initial setting signal, and that the disabling and enabling includes enabling the at least one of the video data signal processing circuitry and the data electrode driver in response to the mute signal being deactivated.

The disabling and enabling preferably includes disabling and enabling an input of the input video data signal in response to the mute signal.

It is also preferable that the disabling and enabling includes disabling and enabling an output of the video data signal in response to the mute signal.

It is also preferable that the disabling and enabling includes disabling and enabling an output of the data clock signal in response to the mute signal.

It is also preferably that the disabling and enabling includes disabling and enabling the data electrode driver in response to the mute signal.

In another aspect of the present invention a method is provided for operating a circuitry including a video data signal processing circuitry generating a video data signal and a data clock signal in response to an input video data signal, a data electrode driver driving a plasma display panel in response to the video data signal and a scan electrode driver operating driving the plasma display panel. The method is composed of:

providing a first supply voltage for an initial setting storage unit to allow the initial setting storage unit to output an initial setting data signal representative of an initial setting;

placing the video data signal processing circuitry in the initial setting in response to the initial setting data signal;

providing a second supply voltage for the scan electrode driver after turn-on of the first supply voltage;

producing a mute signal in response to the initial setting data signal and the second supply voltage; and

disabling and enabling at least one of the video data signal processing circuitry and the data electrode driver in response to the mute signal.

It is preferable that the producing the mute signal preferably includes activating the mute signal in response to the turn-on of the first supply voltage, and the disabling and enabling includes disabling the at least one of the video data signal processing circuitry and the data electrode driver in response to the mute signal being activated.

It is preferable that the producing the mute signal includes:

activating a setting completion signal in response to transfer of the initial setting signal being completed,

activating a voltage ready signal in response to the second supply voltage becoming higher than a predetermined voltage level, and

deactivating the mute signal in response to both of the setting completion signal and the voltage ready signal being activated, and

that the disabling and enabling includes enabling the at least one of the video data signal processing circuitry and the data electrode driver in response to the mute signal being deactivated.

It is advantageous that the producing the mute signal includes activating the mute signal in response to the second supply voltage becoming lower than a predetermined voltage level, and the disabling and enabling includes disabling the at least one of the video data signal processing circuitry and the data electrode driver in response to the mute signal being activated.

In still another aspect of the present invention, a circuitry for driving a plasma display panel is composed of a video data signal processing circuitry producing a video data signal and a data clock signal in response to an input video data signal, a data electrode driver driving the plasma display panel in response to the video data signal and the data clock signal, an initial setting storage circuit outputting an initial setting signal representative of an initial setting in which the video data signal processing circuitry is to be placed, and a mute signal generator producing a mute signal in response to the initial setting signal, wherein at least one of the video data signal processing circuitry and the data electrode driver is disabled and enabled in response to the mute signal.

When the circuitry further includes a power supply providing a supply voltage for the initial setting storage circuit, it is preferable that the mute signal generator activates the mute signal in response to turn-on of the supply voltage, and the at least one of the video data signal processing circuitry and the data electrode driver is disabled in response to the mute signal being activated.

It is preferable that the mute signal generator monitors the initial setting signal to detect completion of transfer of the initial setting signal, and deactivates the mute signal in response to the completion of the transfer of the initial setting, and the at least one of the video data signal processing circuitry and the data electrode driver is enabled in response to the mute signal being deactivated.

Preferably, the circuitry further includes a logic circuitry disabling and enabling an input of the input video data signal to the video data signal processing circuitry in response to the mute signal.

It is also preferable that the circuitry further includes a logic circuitry disabling and enabling an output of the video data signal to the data electrode driver in response to the mute signal.

It is also preferable that the circuitry further includes a logic circuitry disabling and enabling an output of the data clock signal to the data electrode driver in response to the mute signal.

It is also preferable that the data electrode driver is disabled and enabled in response to the mute signal.

In yet still another aspect of the present invention, a circuitry for driving a plasma display panel includes a video data signal processing circuitry producing a video data signal and a data clock signal in response to an input video data signal, a data electrode driver driving the plasma display panel in response to the video data signal and the data clock signal, a first power supply providing a first supply voltage, an initial setting storage circuit operating on the first supply voltage to output an initial setting signal representative of an initial setting in which the video data signal processing circuitry is to be placed, a high-voltage power supply providing a second supply voltage after turn-on of the first supply voltage, a scan electrode driver operating on the second supply voltage to drive the plasma display panel, a mute signal generator producing a mute signal in response to the initial setting signal and the second supply voltage. At least one of the video data signal processing circuitry and the data electrode driver is disabled and enabled in response to the mute signal.

It is preferable that the mute signal generator activates the mute signal in response to the turn-on of the first supply voltage, and the at least one of the video data signal processing circuitry and the data electrode driver is disabled in response to the mute signal being activated.

It is also preferable that the circuitry further includes a voltage monitor circuit activating a voltage ready signal in response to the second supply voltage becoming higher than a predetermined voltage level, and the mute signal generator includes a setting completion detecting circuit activating a setting completion signal in response to transfer of the initial setting signal being completed, and a logic gate deactivating the mute signal in response to both of the setting completion signal and the voltage ready signal being activated, and the at least one of the video data signal processing circuitry and the data electrode driver is enabled in response to the mute signal being deactivated.

It is also preferable that the mute signal generator activates the mute signal in response to the second supply voltage becoming lower than a predetermined voltage level, and the at least one of the video data signal processing circuitry and the data electrode driver is disabled in response to the mute signal being activated.

### BRIEF DESCRIPTION OF THE DRAWINGS

FIG. 1 shows a schematic of a conventional plasma display system;

FIG. 2 shows a schematic of a video data signal generator disposed in the conventional plasma display system;

FIG. 3 is a timing chart illustrating an operation of the conventional plasma display system;

FIG. 4 shows a schematic of a plasma display system in a first embodiment in accordance with the present invention;

FIG. 5 shows a schematic of a video data signal generator disposed in the plasma display system in the first embodiment;

FIG. 6 shows a schematic of a mute signal generator disposed in the plasma display system in the first embodiment;

FIG. 7 is a timing chart illustrating an operation of the plasma display system in the first embodiment;

FIG. 8 shows a schematic of a video data signal generator in a plasma display system in a second embodiment in accordance with the present invention;

FIG. 9 is a timing chart illustrating an operation of the plasma display system in the second embodiment;

FIG. 10 shows a schematic of part of a plasma display system in a third embodiment in accordance with the present invention; and

FIG. 11 shows a schematic of a mute signal generator disposed in a plasma display system in a fourth embodiment in accordance with the present invention.

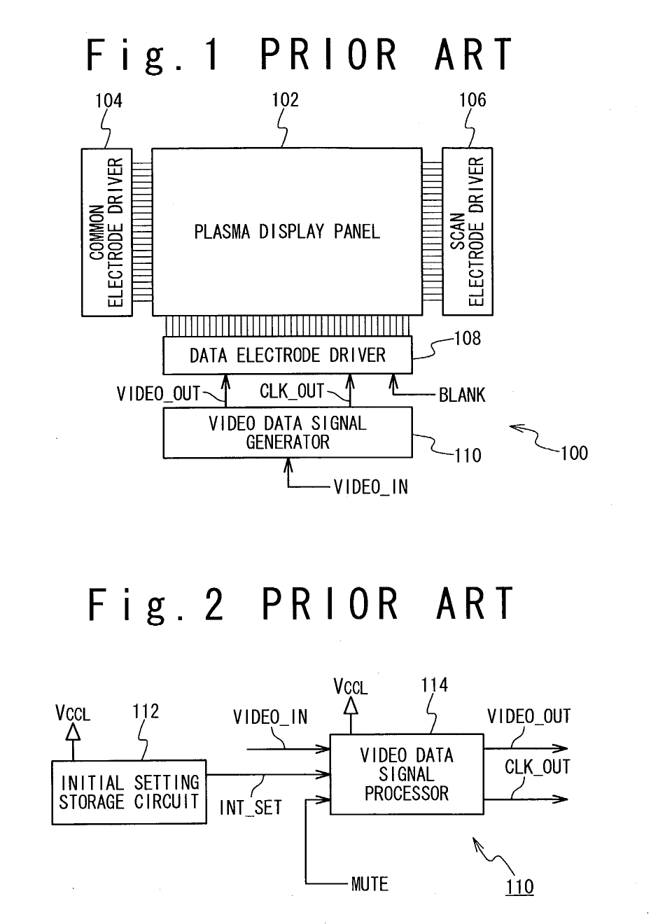

### DESCRIPTION OF THE PREFERRED EMBODIMENTS

The present invention will be described below in detail with reference to the attached drawings.

### First Embodiment

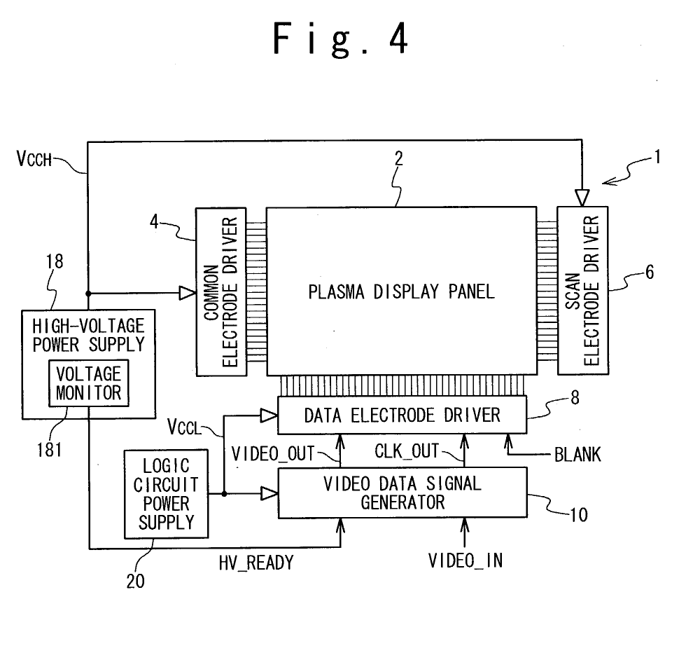

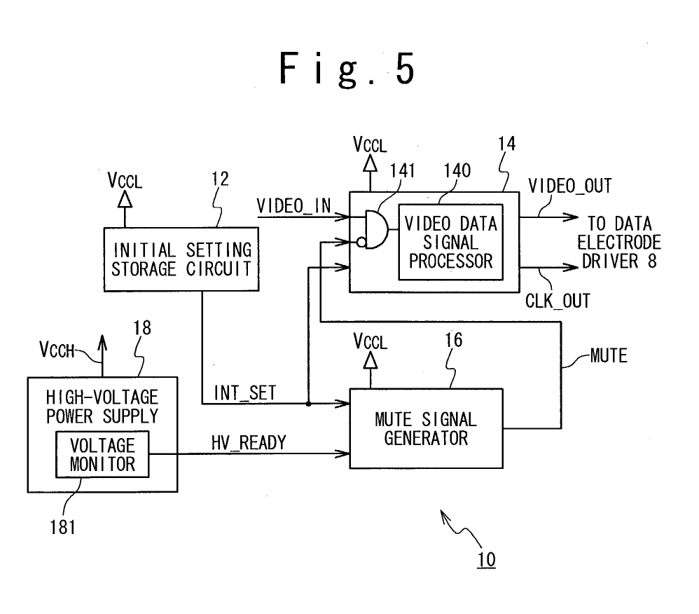

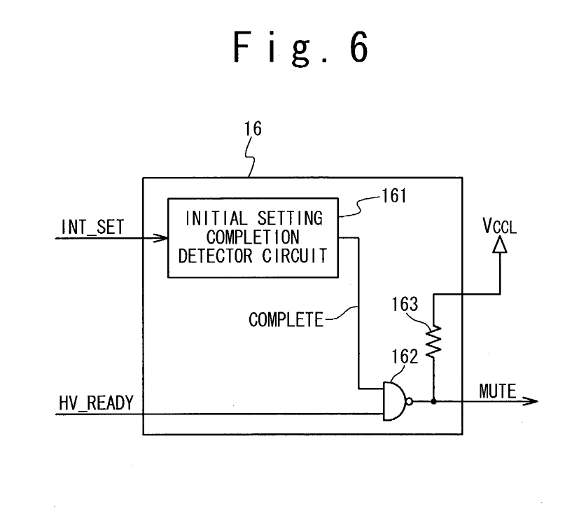

In one embodiment, as shown in FIG. 4, a plasma display system 1 includes a plasma display panel 2, a common electrode driver 4, a scan electrode driver 6, a data electrode driver 8, a video data signal generator 10.

The plasma display panel 2 includes light emitting elements arranged in rows and columns. The light emitting elements are activated by a common electrode, scan electrodes, and data electrodes disposed in the plasma display panel 2.

The common electrode driver 4 develops common pulses on the common electrode, and the scan electrode driver 6 develops scan pulses on the scan electrodes. The common pulses and the scan pulses allow the light emitting elements to start and maintain discharge therein.

The common electrode driver 4 and the scan electrode driver 6, which drives the light emitting elements to maintain gas discharge therein, operates on a high supply voltage V_{CCH} provided by a high-voltage power supply 18. The high-voltage power supply 18 includes a voltage monitor circuit 181 monitoring the high supply voltage V_{CCH}. The voltage monitor circuit 181 activates a high-voltage ready signal HV_READY when the high supply voltage V_{CCH} becomes higher than a predetermined voltage level Vth. The voltage level Vth is determined so that the drive of the plasma display panel 2 is stable.

The data electrode driver 8 receives a video data signal VIDEO_OUT and a data clock signal CLK_OUT from the video data signal generator 10 to drive the data electrodes disposed in the plasma display panel 2. The data electrode driver 8 develops data pulses on the data electrodes in response to the video data signal VIDEO_OUT in synchronization with the data clock signal CLK_OUT.

The data electrode driver 8 and the video data signal generator 10 operate on a logic circuit supply voltage V_{CCL} provided by a logic circuit power supply 20. The high supply voltage V_{CCH} provided for the common electrode driver 4 and the scan electrode driver 6 during normal operation is higher than the logic circuit supply voltage V_{CCL} provided for the data electrode driver 8 and the video data signal generator 10. Thus, the aforementioned voltage level Vth is determined to be higher than the logic circuit supply voltage V_{CCL}.

As shown in FIG. 2, the video data signal generator 10 includes an initial setting storage circuit 12, a PDP video data signal processing circuitry 14, and a mute signal generator 16.

The initial setting storage circuit 12 stores therein an initial setting of the PDP video data signal processing circuitry 14. When the system 1 is started up, the initial setting storage circuit 12 provides an initial setting signal INT_SET representative of the initial setting in which the PDP video data signal processing circuitry 14 is to be placed. The initial setting storage circuit 12 may include a nonvolatile memory device, such as EEPROM (Electrically Erasable Programmable Read Only Memory).

The PDP video data signal processing circuitry 14 includes a video data signal processor 140 and an AND gate 141.

The video data signal processor 140 receives an input video data signal VIDEO_IN through the AND gate 141, and generates the video data signal VIDEO_OUT and the data clock CLK_OUT in response to the input video data signal VIDEO_IN.

The video data signal processor 140 is responsive to the initial setting defined by the initial setting storage circuit 12. When the system 1 is started up, the video data signal processor 140 receives the initial setting signal INT_SET from the initial setting storage circuit 12, and is placed in the initial setting indicated by the initial setting signal INT_SET.

The AND gate 141 receives the input video data signal VIDEO_IN on a first input and a mute signal MUTE from the mute signal generator 16 on a second inverted input. The AND gate 141 selectively provides the input video data signal VIDEO_IN for the video data signal processor 140 in response to the mute signal MUTE. When the mute signal MUTE is activated, the AND gate 141 disables the input of the input video data signal VIDEO_IN.

The mute signal generator 16 is responsive to the initial setting signal INT_SET from the initial setting storage circuit 12 and the high-voltage ready signal HV_READY received from the voltage monitor circuit 181 for producing the mute signal MUTE. As described below, generating the mute signal in response to the initial setting signal INT_SET and the high-voltage ready signal HV_READY achieves fast start-up of the system 1 while avoiding an undesirable image being displayed on the plasma display panel 2.

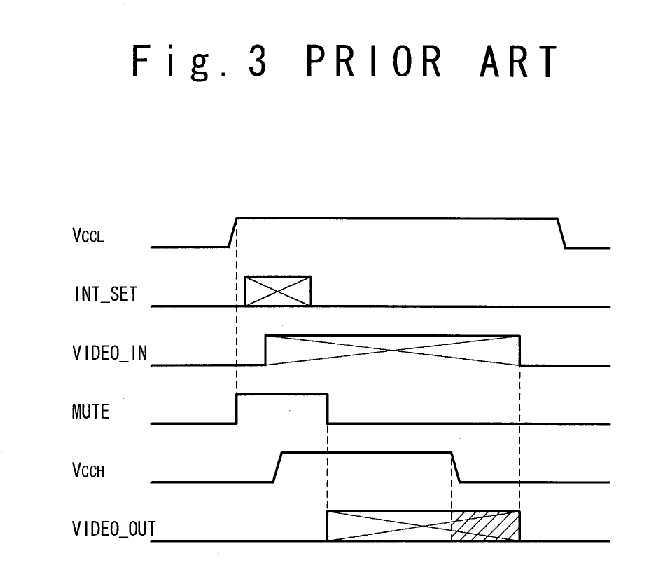

FIG. 3 shows a schematic of the mute signal generator 16. The mute signal generator 16 includes an initial setting completion detector circuit 161 and an NAND gate 162 and a resister 163.

The setting completion detector circuit 161 monitors the initial setting signal INT_SET to detect the completion of transfer of the initial setting from the initial setting storage circuit 12 to the video data signal processor 14. When the initial setting signal INT_SET stays unchanged for a predetermined continuous period, the setting completion detector circuit 161 activate a setting completion signal COMPLETE to represent that the transfer of the initial setting is completed.

The NAND gate 162 receives the setting completion signal COMPLETE and the high-voltage ready signal HV_READY to develop the mute signal MUTE on the output. The mute signal MUTE is provided for the AND gate 141 to disable the input of the input video data signal VIDEO_IN to the video data signal processor 140. The output of the NAND gate 162 is also connected to the logic circuit power supply 20 through the resistor 163. The resistor 163 allows the output of the NAND gate 162 to be activated in response to the logic circuit power supply 20 being turned on, and to be deactivated in response to the logic circuit power supply 20 being turned off.

The setting completion detector circuit 161 and the NAND gate 162 operate on the logic circuit supply voltage V_{CCL} from the logic circuit power supply 20.

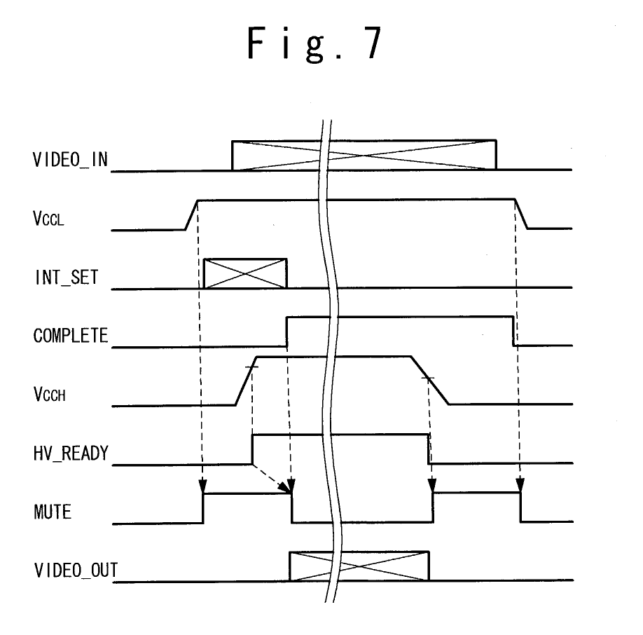

FIG. 7 is a timing chart showing operations of the plasma display system 100. In response to a master electrical switch, typically disposed on a remote control, being turned on, a main power supply of the system 100 is activated. The activation of the main power supply allows the logic circuit supply voltage V_{CCL} to be turned on.

In response to the turn-on of the logic circuit supply voltage V_{CCL}, the setting completion detector circuit 161 and the voltage monitor circuit 181 are reset, and thus the setting completion signal COMPLETE and the high-voltage ready signal HV_READY are deactivated (that is, set to logic “L”). In response to the setting completion signal COMPLETE and the high-voltage ready signal HV_READY being deactivated, the NAND gate 162 in the mute signal generator 16 activates the mute signal MUTE when the logic circuit supply voltage V_{CCL} is turned-on. The activated mute signal MUTE disables the input of the input video data signal VIDEO_IN to the video data signal processor 140.

The turn-on of the logic circuit supply voltage V_{CCL} allows the initial setting storage circuit 12 to start to output the initial setting signal INT_SET to the video data signal processor 140. The transfer of the initial setting by the initial setting signal INT_SET requires a certain period to be completed. When the completion detector circuit 161 detects the completion of the transfer of the initial setting on the basis of the initial setting signal INT_SET, the completion detector circuit 161 activates the setting completion signal COMPLETE. The activated setting completion signal COMPLETE represents that the video data signal processor 140 is ready to produce the video data signal VIDEO_OUT.

In the meantime, the high supply voltage V_{CCH} is turned on by the high-voltage power supply 18. The voltage monitor circuit 181, disposed in the high-voltage power supply 18, monitors the high supply voltage V_{CCH}, and activates the high-voltage ready signal HV_READY when the high supply voltage V_{CCH} becomes higher than the predetermined voltage level Vth. The activated high-voltage ready signal HV_READY represents that the common electrode driver 4 and the scan electrode driver 6 are ready to drive the plasma display panel 2.

In response to both of the setting completion signal COMPLETE and the high-voltage ready signal HV_READY being activated, the mute signal MUTE is deactivated to allow the video data signal processor 140 to provide the video data signal VIDEO_OUT for the data electrode driver 8. It should be noted that the activation of only one of the setting completion signal COMPLETE and the high-voltage ready signal HV_READY does not allow the mute signal MUTE to be deactivated. Then the common electrode driver 4, the scan electrode driver 6, and the data electrode driver 8 starts to drive the plasma display panel 2 to display a desired image thereon.

The input of the input video data signal VIDEO_IN may start before the transfer of the initial setting is complete or before the high supply voltage V_{CCH} becomes higher than the predetermined voltage level Vth. However, the architecture thus-described effectively avoids an undesirable image being displayed on the plasma display panel 2, because the mute signal MUTE is kept activated till the transfer of the initial setting is complete and the high supply voltage V_{CCH} becomes higher than the predetermined voltage level Vth.

On the other hand, the architecture thus-described is also effective in fast start-up of the plasma display system 1. The timing of the deactivation of the mute signal MUTE is determined in response to the setting completion signal COMPLETE and the high-voltage ready signal HV_READY, and thus the mute signal MUTE is deactivated as soon as the transfer of the initial setting is completed and the high supply voltage V_{CCH} is turned on. The flexible deactivation of the mute signal MUTE facilitates the fast start-up of the plasma display system 1.

The architecture thus-described also avoids an undesirable image being displayed on the plasma display panel 2 when the master electrical switch of the plasma display system 1 is turned off.

When the master electrical switch of the system1 is turned off, the high-voltage power supply 18 turns off the high supply voltage V_{CCH}. The voltage monitor circuit 181 deactivates the high-voltage ready signal HV_READY when detecting that the high supply voltage V_{CCH} is turned off, that is, detecting that the high supply voltage V_{CCH} becomes lower than the predetermined voltage level Vth. The deactivation of the high-voltage ready signal HV_READY causes the NAND gate 162 in the mute signal generator 16 to activate the mute signal MUTE.

In response to the mute signal MUTE being activated, the AND gate 141 in the PDP video data signal processing circuitry 14 disables the provision of the input video data signal VIDEO_IN for the video data signal processor 140. This results in that the video data signal processor 140 stops outputting the video data signal VIDEO_OUT. Accordingly, the erroneous display of an undesirable image is avoided after the turn-off of the high supply voltage V_{CCH}.

Then, the logic circuit power supply 18 turn off the logic circuit supply voltage V_{CCL}. The turn-off of the logic circuit supply voltage V_{CCL} deactivates the NAND gate 162 and stops the supply of logic circuit supply voltage V_{CCL} on the output of the NAND gate 162 through the resister 163. Thus, the mute signal MUTE is deactivated.

As just described, the architecture in this embodiment effectively avoids an undesirable image being displayed on the plasma display panel 2 while achieving fast start-up of the system 1. In addition, the architecture in this embodiment effectively avoids an undesirable image being displayed on the plasma display panel 2 when the main power supply of the system 1 is turned off.

### Second Embodiment

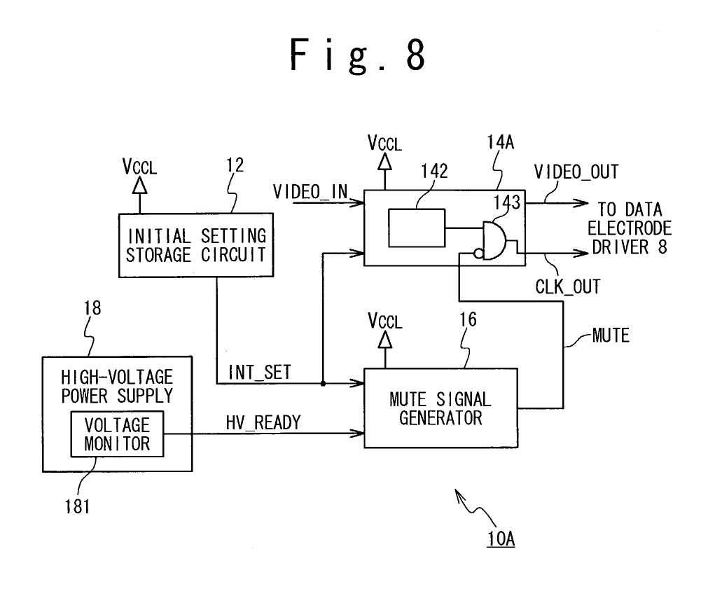

In a second embodiment, a video data signal generator 10A shown in FIG. 8 is provided for the plasma display system 1 in place of the video data signal generator 10 used in the first embodiment. The difference between the video data signal generators 10 and 10A is that the video data signal generator 10A deactivates the data clock signal CLK_OUT in response to the activation of the mute signal MUTE, instead of disabling the input of the input video data signal VIDEO_IN.

The architecture of the video data signal generator 10A is identical to the video data signal generator 10, except that the video data signal generator 10A includes a PDP video data signal processing circuitry 14A in place of the PDP video data signal processing circuitry 14. The PDP video data signal processing circuitry 14A produces the video data signal VIDEO_OUT in response to the input video data signal VIDEO_IN. The PDP video data signal processing circuitry 14A receives the initial setting signal INT_SET from the initial setting storage circuit 12 to be placed in the initial setting indicated by the initial setting signal INT_SET.

The PDP video data signal processing circuitry 14A includes a data clock signal generator 142 and an AND gate 143. The data clock signal generator 142 produces the data clock signal CLK_OUT in response to the input video data signal VIDEO_IN. The AND gate 143 receives the data clock signal CLK_OUT from the data clock signal generator 142 on a first input, and the mute signal MUTE from the mute signal generator 16 on a second inverted input.

The AND gate 143 selectively outputs the data clock signal CLK_OUT to the data electrode driver 8 in response to the mute signal MUTE. When the mute signal MUTE is deactivated, the AND gate 143 outputs the data clock signal CLK_OUT from its output. On the other hand, the AND gate 143 disables the output of the data clock signal CLK_OUT when the mute signal MUTE is activated.

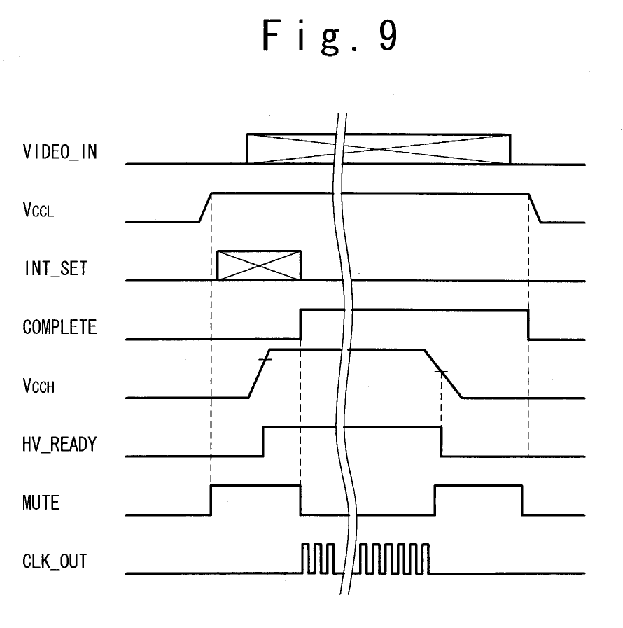

FIG. 9 is a timing chart illustrating the operation of the plasma display system 1 in the second embodiment.

The generation of the mute signal MUTE in the second embodiment is achieved through the same process as the first embodiment. In response to the turn-on of the logic circuit supply voltage V_{CCL}, the mute signal MUTE is activated by the NAND gate 162 disposed in the mute signal generator 16.

The activation of the mute signal MUTE disables the output of the data clock signal CLK_OUT to the data electrode driver 8. In response to the data clock signal CLK_OUT being disabled, the data electrode driver 8 fails to fetch the video data signal VIDEO_OUT, and thus the erroneous drive of the plasma display panel 2 is avoided.

The mute signal MUTE is deactivated in response to both of the setting completion signal COMPLETE and the high-voltage ready signal HV_READY being activated. In response to the deactivation of the mute signal MUTE, the AND gate 143 starts to output the data clock signal CLK_OUT to allow the data electrode driver 8 to drive the plasma display panel 2 in response to the video data signal VIDEO_OUT.

Therefore, the architecture in the second embodiment effectively avoids an undesirable image being displayed when the system 1 is started up. The PDP video data signal circuitry 14A may start to provide the video data signal VIDEO_OUT in response to the input video data signal VIDEO_IN before the initial setting of the PDP video data signal circuitry 14A is completed or before the turn-on of the high supply voltage V_{CCH}. However, it does not causes the erroneous display of an undesirable image on the plasma display panel 2, because the output of the data clock signal CLK_OUT is disabled while any one of the initial setting of the PDP video data signal circuitry 14A and the turn-on of the high supply voltage V_{CCH} is not yet completed.

In addition, in the same way as the first embodiment, the architecture in the second embodiment facilitates fast start-up of the system 1, because the mute signal MUTE is flexibly deactivated to allow the provision of data clock signal CLK_OUT in response to the activation of the setting completion signal COMPLETE and the high-voltage ready signal HV_READY.

Furthermore, in the same way as the first embodiment, the architecture in the second embodiment effectively avoids an undesirable image being displayed on the plasma display panel 2 when the master electrical switch of the plasma display system 1 is turned off. When the master electrical switch of the display system 1 is turned off, the mute signal MUTE is activated in response to the turned-off of the high supply voltage V_{CCH}. The activation of the mute signal MUTE effectively avoids an undesirable image being displayed on the plasma display panel 2 after the turn-off of the high supply voltage V_{CCH}.

In the second embodiment, the AND gate 143 may receive the video data signal VIDEO_OUT instead of the data clock signal CLK_OUT on the first input. In this case, the activation of the mute signal MUTE disables the video data signal VIDEO_OUT. Those who skilled in the art would appreciate that this modification also facilitates fast start-up of the system 1 while avoiding an undesirable image being displayed on the plasma display panel 2.

### Third Embodiment

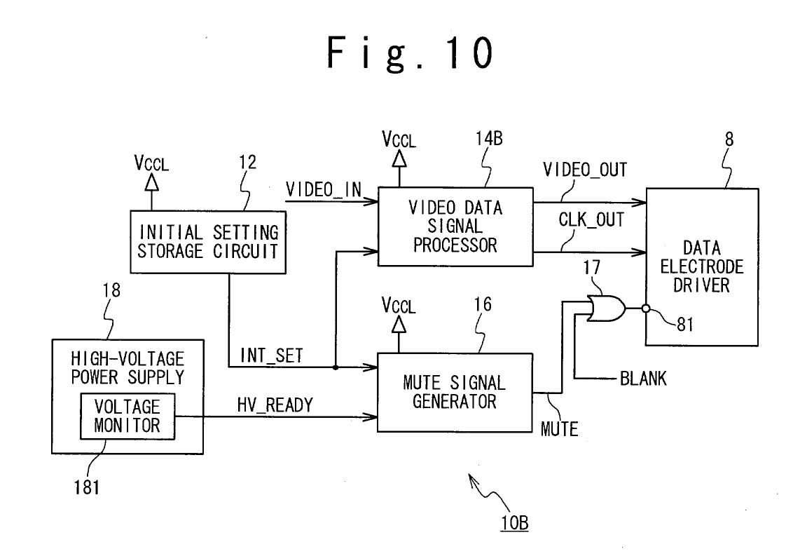

In a third embodiment, as shown in FIG. 10, the plasma display system 1 is modified as described below. The video data signal generator 10B is provided for the system 1 in place of the video data signal generator 10. The video data signal generator 10B includes the initial setting storage circuit 12 and mute signal generator 16 in the same way as the video data signal generator 10 in the first embodiment.

The video data signal generator 10B includes a video data signal processor 14B to produce the video data signal VIDEO_OUT and the data clock signal CLK_OUT. The video data signal processor 14B receives the initial setting signal INT_SET to be placed in the initial setting indicated by the initial setting signal INT_SET.

The plasma display system 1 further includes an OR gate 17. The OR gate 17 receives the mute signal MUTE, generated by the mute signal generator 16, on a first input, and the blanking signal BLANK on a second input. The OR gate 17 activates its output when at least one of the mute signal MUTE and the blanking signal BLANK is activated. The output of the OR gate 17 is connected to an blanking terminal 81 of the data electrode driver 8. In response to the output of the OR gate 17 activated, the data electrode driver 8 is deactivated.

The generation of the mute signal MUTE in the third embodiment is achieved through the same process as the first embodiment. In response to the turn-on of the logic circuit supply voltage V_{CCL}, the mute signal MUTE is activated by the NAND gate 162 disposed in the mute signal generator 16.

In response to the activation of the mute signal MUTE, the output of the OR gate 17 is activated. The activation of the output of the OR gate 17 disables the data electrode driver 8.

The mute signal MUTE is deactivated in response to both of the setting completion signal COMPLETE and the high-voltage ready signal HV_READY being activated. In response to the deactivation of the mute signal MUTE, the output of the OR gate 17 is deactivated to allow the data electrode driver 8 to drive the plasma display panel 2 in response to the video data signal VIDEO_OUT and the data clock signal CLK_OUT.

Therefore, the architecture in the third embodiment effectively avoids an undesirable image being displayed when the system 1 is started up. The PDP video data signal circuitry 14B may start to provide the video data signal VIDEO_OUT in response to the input video data signal VIDEO_IN before the initial setting of the PDP video data signal circuitry 14B is completed or before the turn-on of the high supply voltage V_{CCH}. However, it does not causes the erroneous display of an undesirable image on the plasma display panel 2, because the data electrode driver 8 is disabled while any one of the initial setting of the PDP video data signal circuitry 14B and the turn-on of the high supply voltage V_{CCH} is not yet completed.

In addition, in the same way as the first embodiment, the architecture in the third embodiment facilitates fast start-up of the system 1, because the mute signal MUTE is flexibly deactivated to allow the provision of data clock signal CLK_OUT in response to the activation of the setting completion signal COMPLETE and the high-voltage ready signal HV_READY.

Furthermore, in the same way as the first embodiment, the architecture in the second embodiment effectively avoids an undesirable image being displayed on the plasma display panel 2 when the master electrical switch of the plasma display system 1 is turned off. When the master electrical switch of the display system 1 is turned off, the mute signal MUTE is activated in response to the turned-off of the high supply voltage V_{CCH}. The activation of the mute signal MUTE effectively avoids an undesirable image being displayed on the plasma display panel 2 after the turn-off of the high supply voltage V_{CCH}.

### Fourth Embodiment

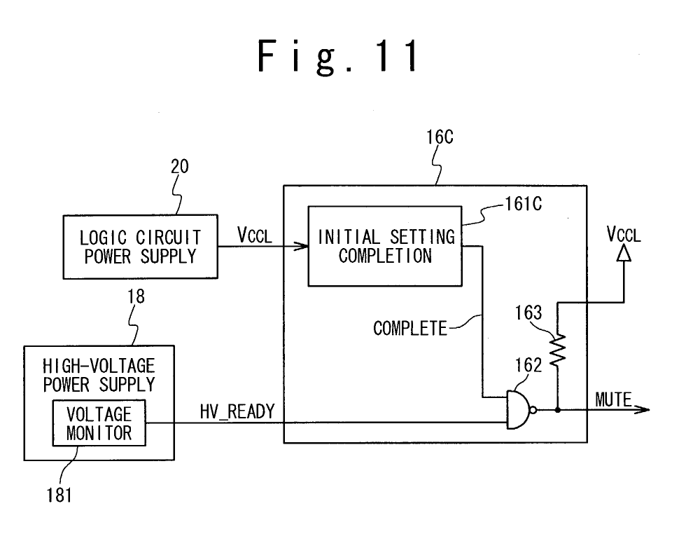

In a fourth embodiment, the mute signal generator 16 is replaced with a mute signal generator 16C shown in the FIG. 11. T he mute signal generator 16C may be implemented within the system 1 in any of the first to third embodiments. The mute signal generator 16C generates the mute signal MUTE in response to the turn-on of the logic circuit supply voltage V_{CCL} instead of the initial setting signal INT_SET.

The mute signal generator 16C, which is provided with the NAND gate 162 and the resistor 163 in the same way as the mute signal generator 16, includes an initial setting completion detector circuit 161C instead of the initial setting completion detector circuit 161.

The initial setting completion detector circuit 161C produces the setting complete signal COMPLETE in response to the turn-on of the logic circuit supply voltage V_{CCL}. The initial setting completion detector circuit 161C activates the setting complete signal COMPLETE upon the turn-on of the logic circuit supply voltage V_{CCL} till the transfer of the initial setting signal INT_SET is completed. The initial setting completion detector circuit 161C deactivates the setting complete signal COMPLETE upon the turn-off of the logic circuit supply voltage V_{CCL}.

In this embodiment, the start-up of the system 1 is achieved as described in the following. In response to the turn-on of the master electrical switch of the system 1, the logic circuit power supply 20 turns on the logic circuit supply voltage V_{CCL}. In response to the turn-on of the logic circuit supply voltage V_{CCL}, the initial setting completion detector circuit 161C deactivates the setting completion signal COMPLETE. The NAND gate 162 activates the mute signal MUTE in response to the deactivation of the setting completion signal COMPLETE. The activation of the mute signal MUTE disables one of the input video data signal VIDEO_IN, the output of the data clock signal CLK_OUT, and the video data signal VIDEO_OUT, or disables the data electrode driver 8 to avoid an undesirable image being displayed on the panel 2.

In the meantime, the high-voltage power supply 18 is turned on, and the high-voltage ready signal HV_READY is activated by the voltage monitor circuit 181 in response to the turn-on of the high supply voltage V_{CCH}.

The completion detector circuit 161C activates the setting complete signal COMPLETE when the transfer of the initial setting signal INT_SET is completed.

In response to both of the setting complete signal COMPLETE and the high-voltage ready signal HV_READY being activated, the mute signal MUTE is deactivated. The deactivation of the mute signal MUTE allows the data electrode driver 8 to drive the plasma display panel 2 to display a desired image thereon.

The aforementioned architecture in the fourth embodiment effectively avoids an undesirable image being displayed when the system 1 is started up. The mute signal MUTE is activated upon the turn-on of the logic circuit supply voltage V_{CCL}, and is deactivated after the initial setting of the video data signal processor is completed and the high supply voltage V_{CCH} is turned on. This effectively avoids the erroneous display of an undesirable image on the plasma display panel 2, because the data electrode driver 8 is substantially disabled while any one of the initial setting of the PDP video data signal circuitry 14B and the turn-on of the high supply voltage V_{CCH} is not yet completed.

Furthermore, in the same way as the first embodiment, the architecture in the fourth embodiment effectively avoids an undesirable image being displayed on the plasma display panel 2 when the master electrical switch of the plasma display system 1 is turned off. When the master electrical switch of the display system 1 is turned off, the mute signal MUTE is activated in response to the turned-off of the high supply voltage V_{CCH}. The activation of the mute signal MUTE effectively avoids an undesirable image being displayed on the plasma display panel 2 after the turn-off of the high supply voltage V_{CCH}.

In this embodiment, the setting completion detector circuit 161C may determine the timing of the deactivation of the setting complete signal COMPLETE by counting the period necessary for the transfer of the initial setting signal INT_SET in synchronization with a clock signal. The necessary period may include a margin.

Although the invention has been described in its preferred form with a certain degree of particularity, it is understood that the present disclosure of the preferred form has been changed in the details of construction and the combination and arrangement of parts may be resorted to without departing from the spirit and the scope of the invention as hereinafter claimed.

What is claimed is:

1. A method of operating a circuitry including a video data signal processing circuitry generating a video data signal and a data clock signal in response to an input video data signal, and a data electrode driver driving a plasma display panel in response to said video data signal, said method comprising:
allowing an initial setting storage unit to output an initial setting data signal representative of an initial setting of said video data signal processing circuitry;
placing said video data signal processing circuitry in said initial setting in response to said initial setting data signal;
producing a mute signal in response to said initial setting data signal; and
disabling and enabling at least one of said video data signal processing circuitry and said data electrode driver in response to said mute signal.

2. The method according to claim 1, wherein said allowing includes:
providing a supply voltage for said initial setting storage circuit,
wherein said producing said mute signal includes:
activating said mute signal in response to turn-on of said supply voltage, and
wherein said disabling and enabling includes:
disabling said at least one of said video data signal processing circuitry and said data electrode driver in response to said mute signal being activated.

3. The method according to claim 1, wherein said producing said mute signal includes:
monitoring said initial setting signal to detect completion of transfer of said initial setting, and
deactivating said mute signal in response to said completion of said transfer of said initial setting signal, and
wherein said disabling and enabling includes enabling said at least one of said video data signal processing circuitry and said data electrode driver in response to said mute signal being deactivated.

4. The method according to claim 1, wherein said disabling and enabling includes:
disabling and enabling an input of said input video data signal in response to said mute signal.

5. The method according to claim 1, wherein said disabling and enabling includes:
disabling and enabling an output of said video data signal in response to said mute signal.

6. The method according to claim 1, wherein said disabling and enabling includes:
disabling and enabling an output of said data clock signal in response to said mute signal.

7. The method according to claim 1, wherein said disabling and enabling includes:
disabling and enabling said data electrode driver in response to said mute signal.

8. A method of operating a circuitry including a video data signal processing circuitry generating a video data signal and a data clock signal in response to an input video data signal, a data electrode driver driving a plasma display panel in response to said video data signal and a scan electrode driver operating driving said plasma display panel, said method comprising:
providing a first supply voltage for an initial setting storage unit to allow said initial setting storage unit to output an initial setting data signal representative of an initial setting;
placing said video data signal processing circuitry in said initial setting in response to said initial setting data signal;
providing a second supply voltage for said scan electrode driver after turn-on of said first supply voltage;
producing a mute signal in response to said initial setting data signal and said second supply voltage; and
disabling and enabling at least one of said video data signal processing circuitry and said data electrode driver in response to said mute signal.

9. The method according to claim 8, wherein said producing said mute signal includes:
activating said mute signal in response to said turn-on of said first supply voltage, and
wherein said disabling and enabling includes:
disabling said at least one of said video data signal processing circuitry and said data electrode driver in response to said mute signal being activated.

10. The method according to claim 8, wherein said producing said mute signal includes:
activating a setting completion signal in response to transfer of said initial setting signal being completed,
activating a voltage ready signal in response to said second supply voltage becoming higher than a predetermined voltage level, and
deactivating said mute signal in response to both of said setting completion signal and said voltage ready signal being activated, and
wherein said disabling and enabling includes enabling said at least one of said video data signal processing circuitry and said data electrode driver in response to said mute signal being deactivated.

11. The method according to claim 8, wherein said producing said mute signal includes:
activating said mute signal in response to said second supply voltage becoming lower than a predetermined voltage level, and
wherein said disabling and enabling includes:
disabling said at least one of said video data signal processing circuitry and said data electrode driver in response to said mute signal being activated.

12. The method according to claim 8, wherein said disabling and enabling includes:
disabling and enabling an input of said input video data signal in response to said mute signal.

13. The method according to claim 8, wherein said disabling and enabling includes:
disabling and enabling an output of said video data signal in response to said mute signal.

14. The method according to claim 8, wherein said disabling and enabling includes:
disabling and enabling an output of said data clock signal in response to said mute signal.

15. The method according to claim 8, wherein said disabling and enabling includes:
disabling and enabling said data electrode driver in response to said mute signal.

16. A circuitry for driving a plasma display panel comprising:
a video data signal processing circuitry producing a video data signal and a data clock signal in response to an input video data signal;
a data electrode driver driving said plasma display panel in response to said video data signal and said data clock signal;
an initial setting storage circuit outputting an initial setting signal representative of an initial setting in which said video data signal processing circuitry is to be placed;
a mute signal generator producing a mute signal in response to said initial setting signal, wherein at least one of said video data signal processing circuitry and said data electrode driver is disabled and enabled in response to said mute signal.

17. The circuitry according to claim 16, further comprising:
a power supply providing a supply voltage for said initial setting storage circuit,
wherein said mute signal generator activates said mute signal in response to turn-on of said supply voltage, and
wherein said at least one of said video data signal processing circuitry and said data electrode driver is disabled in response to said mute signal being activated.

18. The circuitry according to claim 16, wherein said mute signal generator monitors said initial setting signal to detect completion of transfer of said initial setting signal, and deactivates said mute signal in response to said completion of said transfer of said initial setting, and
wherein said at least one of said video data signal processing circuitry and said data electrode driver is enabled in response to said mute signal being deactivated.

19. The circuitry according to claim 16, further comprising:
a logic circuitry disabling and enabling an input of said input video data signal to said video data signal processing circuitry in response to said mute signal.

20. The circuitry according to claim 16, further comprising:
a logic circuitry disabling and enabling an output of said video data signal to said data electrode driver in response to said mute signal.

21. The circuitry according to claim 16, further comprising:
a logic circuitry disabling and enabling an output of said data clock signal to said data electrode driver in response to said mute signal.

22. The circuitry according to claim 16, wherein said data electrode driver is disabled and enabled in response to said mute signal.

23. A circuitry for driving a plasma display panel comprising:
a video data signal processing circuitry producing a video data signal and a data clock signal in response to an input video data signal;
a data electrode driver driving said plasma display panel in response to said video data signal and said data clock signal;
a first power supply providing a first supply voltage;
an initial setting storage circuit operating on said first supply voltage to output an initial setting signal representative of an initial setting in which said video data signal processing circuitry is to be placed;
a high-voltage power supply providing a second supply voltage after turn-on of said first supply voltage;
a scan electrode driver operating on said second supply voltage to drive said plasma display panel;
a mute signal generator producing a mute signal in response to said initial setting signal and said second supply voltage, wherein at least one of said video data signal processing circuitry and said data electrode driver is disabled and enabled in response to said mute signal.

24. The circuitry according to claim 23, wherein said mute signal generator activates said mute signal in response to said turn-on of said first supply voltage, and
wherein said at least one of said video data signal processing circuitry and said data electrode driver is disabled in response to said mute signal being activated.

25. The circuitry according to claim 23, further comprising:
a voltage monitor circuit activating a voltage ready signal in response to said second supply voltage becoming higher than a predetermined voltage level,
wherein said mute signal generator includes:
a setting completion detecting circuit activating a setting completion signal in response to transfer of said initial setting signal being completed, and
a logic gate deactivating said mute signal in response to both of said setting completion signal and said voltage ready signal being activated, and
wherein said at least one of said video data signal processing circuitry and said data electrode driver is enabled in response to said mute signal being deactivated.

26. The circuitry according to claim 23, wherein said mute signal generator activates said mute signal in response to said second supply voltage becoming lower than a predetermined voltage level, and
wherein said at least one of said video data signal processing circuitry and said data electrode driver is disabled in response to said mute signal being activated.

27. The circuitry according to claim 23, further comprising:
a logic circuitry disabling and enabling an input of said input video data signal to said video data signal processing circuitry in response to said mute signal.

28. The circuitry according to claim 23, further comprising:
a logic circuitry disabling and enabling an output of said video data signal to said data electrode driver in response to said mute signal.

29. The circuitry according to claim 23, a logic circuitry disabling and enabling an output of said data clock signal to said data electrode driver in response to said mute signal.

30. The circuitry according to claim 23, wherein said data electrode driver is disabled and enabled in response to said mute signal.
